(19) United States
(12) Patent Application Publication
(10) Pub. No.: US 2007/0059481 A1
(43) Pub. Date: Mar. 15, 2007

(54) Floor pads

(76) Inventor: Chien Jen Lin, Jhonghe City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/227,748

(22) Filed: Sep. 15, 2005

(51) Int. Cl. B32B 3/02; B32B 3/10

(52) U.S. Cl. 428/80; 428/44

(57) ABSTRACT

A square-shaped floor pad includes two protrusions extending from two adjacent sides of each of the two corners on a first diagonal axis of the pad and two recesses are defined in two adjacent sides of each of two corners on a second diagonal axis of the pad. The protrusions are shaped to be matched with the recesses. The floor pads are able to be matched with each other by engaging the protrusion with the recesses in different directions and sides.

### FIELD OF THE INVENTION

The present invention relates to floor pads which can be connected with each other in different ways.

### BACKGROUND OF THE INVENTION

Conventional floor pads which are able to be connected with each other by engaging protrusions of one floor pad with recesses of another floor pad. The conventional floor pads have to include same shape of corners and angles or they cannot be matched with each other. The shapes of the protrusions and the recesses are designed to be matched with each other. This limits the floor pads to be matched in one direction and cannot have different patterns of combination.

The present invention intends to provide a floor pad which includes two protrusions extending from two adjacent sides of each of two corners on a diagonal axis of the pad and two recesses are defined in two adjacent sides of each of two corners on another diagonal axis of the pad. The floor pads are allowed to be matched with each other in different directions and have different patterns of combination.

### SUMMARY OF THE INVENTION

The present invention relates to a floor pad includes four sides and four right-angled corners. Two protrusions extend from two adjacent sides of each of the two corners on a first diagonal axis of the pad and two recesses are defined in two adjacent sides of each of two corners on a second diagonal axis of the pad. The protrusions are shaped to be matched with the recesses. A distal end of each of the protrusions and an inside of each of the recesses are located at two parallel horizontal planes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the floor pad of the present invention;

FIG. 2 is a top view of the floor pad of the present invention;

FIGS. 3 and 4 show two different patterns of combination of the floor pads;

FIG. 5 shows a cover is attached on the floor pad, and

FIG. 6 shows the protrusions can be cut and engaged with the recesses.

### DETAILED DESCRIPTION OF THE PREFERRED EMBODIMENT

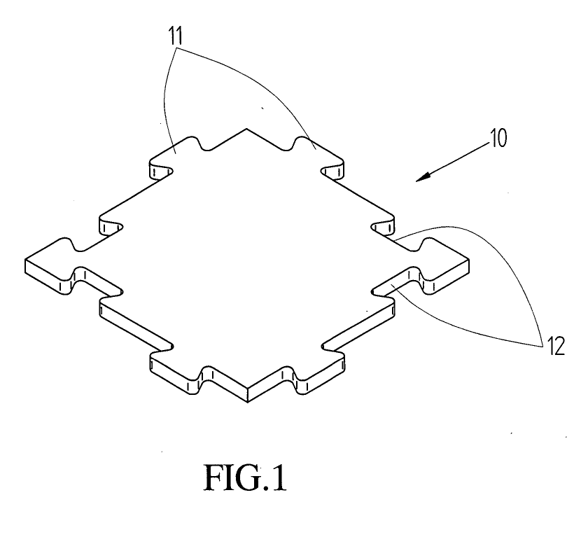

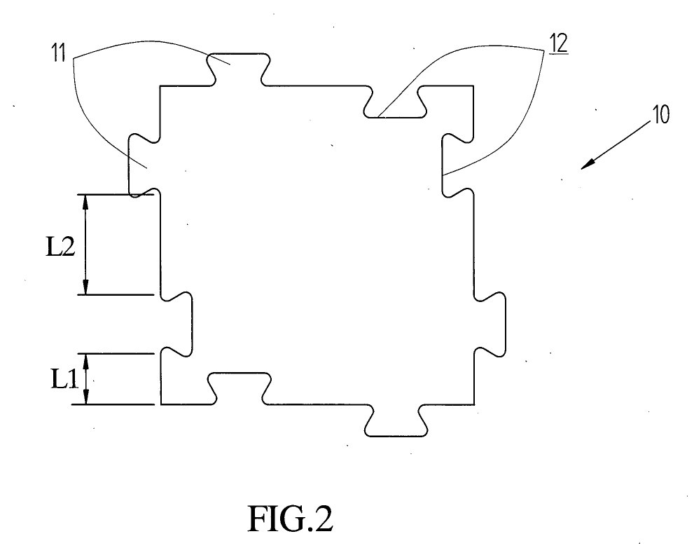

Referring to FIGS. 1 and 2, the floor pad 10 of the present invention is a square floor pad and comprises four sides and four right-angled corners. Two protrusions 11 extend from two adjacent sides of each of the two corners on a first diagonal axis of the pad 10 and two recesses 12 are defined in two adjacent sides of each of two corners on a second diagonal axis of the pad 10. The first and second diagonal axes are perpendicular with each other. The protrusions 11 are shaped to be matched with the recesses 12. A distal end of each of the protrusions 11 and an inside of each of the recesses 12 are located at two parallel horizontal planes. As indicated in FIG. 2, the length “L1” between one of the corners of the second diagonal axis of the floor pad 10 to the closest inner end of the recess is only half of the length “L2” from the other inner end of the recess 12 to the protrusion 11 on the same side of the floor pad 10.

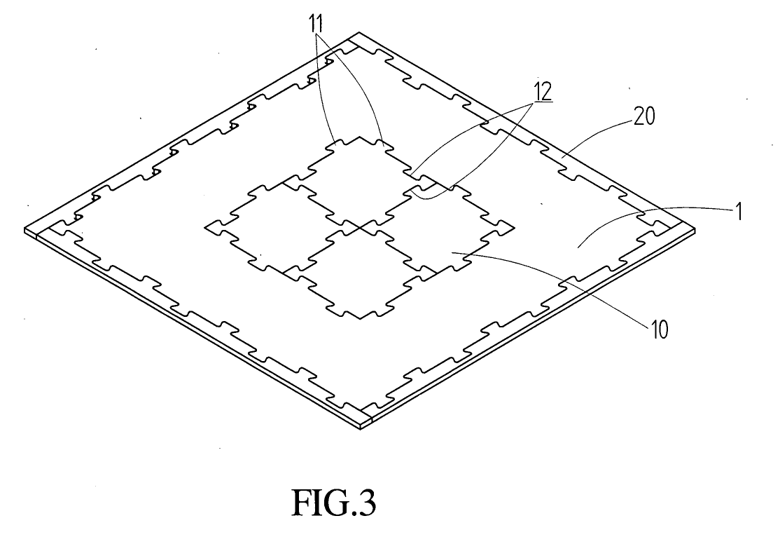

FIG. 3 shows a first pattern of the combination of the floor pads 10 wherein a large pad 1 has a central hole defined therethrough so that four floor pads 10 are arranged to fit in the central hole by engaging the protrusions 11 with recesses 12. The periphery of the large pad 1 is enclosed by a plurality of peripheral pads 20.

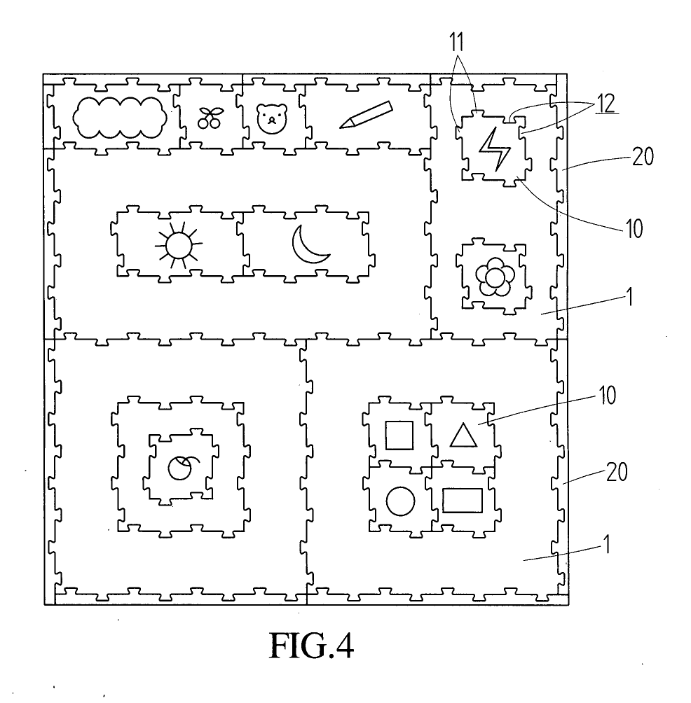

FIG. 4 shows a second pattern of the combination of the floor pads 10 wherein several large pads 1 are combined as a large square area and each of the large pads 1 has at least one hole defined therethrough so that the floor pads 10 of the present invention are arranged to fit in the at least one hole by engaging the protrusions 11 with recesses 12. The periphery of the large square area is enclosed by a plurality of peripheral pads 20. The floor pads 10 can be made to have patterns or pictures on their surfaces when needed.

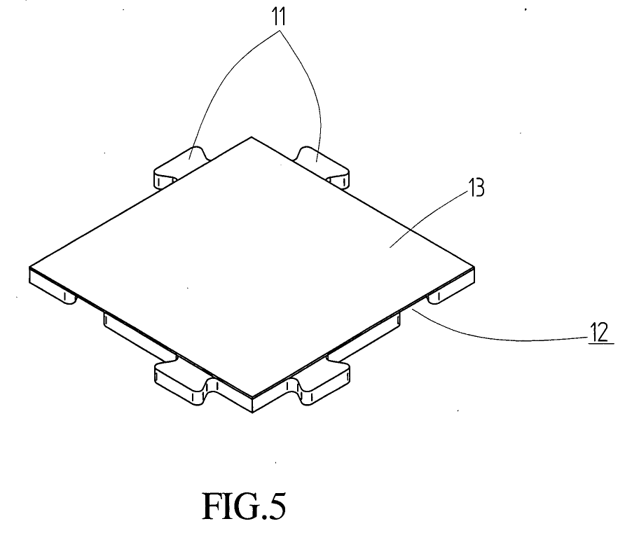

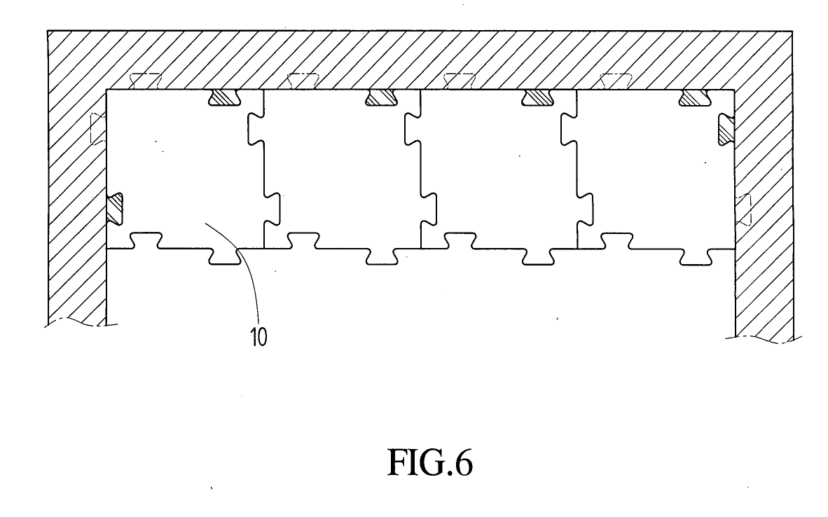

FIG. 5 shows that a cover plate 13 can be attached on the floor pad 10 and four sides of the cover 13 are in flush with the four sides of the floor pad 10 so that the floor pads 10 can be hidden by the cover plate 13. FIG. 6 shows a frame is used to enclose the floor pads 10 and the insides of the frame are in flush with the sides of the combination of the floor pads 10. The protrusions 11 can be cut and fit in the recesses 12.

The floor pads 10 can be made by any known material such as foam, rubber, plastic, wood, fabrics or bamboos.

While we have shown and described the embodiment in accordance with the present invention, it should be clear to those skilled in the art that further embodiments may be made without departing from the scope of the present invention.

What is claimed is:

1. A floor pad comprising:
four sides and four right-angled corners, two protrusions extending from two adjacent sides of each of the two corners on a first diagonal axis of the pad and two recesses defined in two adjacent sides of each of two corners on a second diagonal axis of the pad, the protrusions being shaped to be matched with the recesses, a distal end of each of the protrusions and an inside of each of the recesses being located at two parallel horizontal planes.

2. The floor pad as claimed in claim 1, wherein a cover plate is attached on the floor pad and four sides of the cover are in flush with the four sides of the floor pad.

3. The floor pad as claimed in claim 1, wherein a length “L1” between one of the corners of the second diagonal axis of the floor pad to the closest inner end of the recess is half of the length “L2” from the other inner end of the recess to the protrusion on the same side of the floor pad.

4. The floor pad as claimed in claim 1, wherein the floor pads are made by foam.

5. The floor pad as claimed in claim 1, wherein the floor pads are made by plastic.

6. The floor pad as claimed in claim 1, wherein the floor pads are made by wood.

7. The floor pad as claimed in claim 1, wherein the floor pads are made by fabrics.

8. The floor pad as claimed in claim 1, wherein the floor pads are made by bamboos.
